(19) United States
(12) Patent Application Publication
(10) Pub. No.: US 2008/0066872 A1
(43) Pub. Date: Mar. 20, 2008

(54) Drywall tape dispensing system

(76) Inventor: Mack Rose, North Canton, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/523,130

(22) Filed: Sep. 18, 2006

(51) Int. Cl. B44C 7/00

(52) U.S. Cl. 156/574

(57) ABSTRACT

A drywall tape dispensing system includes an open-ended container that retains drywall compound and a drywall tape dispenser that extends downwardly into the drywall compound. The drywall tape dispenser includes a frame having a feed end, a dispensing end, and a support portion. The support portion rests within the drywall compound. A roll of drywall tape is retained at the feed end and the leading edge of the tape extends beneath a support guide on a support portion, and, from there, extends to a metering guide near the dispensing end. As the leading edge of the tape is pulled, additional length of tape is pulled down from the drywall compound under the support guide and then is ultimately dispensed through the metering guide at the dispensing end.

### TECHNICAL FIELD

The present invention generally relates to apparatus for aiding in the installation of drywall and, more particularly, relates to a drywall tape dispensing system that facilitates the process of taping drywall seams.

### BACKGROUND OF THE INVENTION

After drywall is installed, the seams formed by abutting edges of drywall panels are taped so that the wall and/or ceiling covered with the sheets of drywall can appear as one unitary smooth surface. The edges of drywall panels are typically tapered to receive drywall tape, which is covered with multiple coats of drywall compound to smooth and hide the seam for subsequent wallpapering or painting or other form of finish.

The drywall tape might have an adhesive on one side such that it can be taken off a roll and firmly pressed into place across the seam of two abutting drywall panels, or it might simply be a strip of mesh tape that has no adhesive, such that it must be coated on at least one side with drywall compound so that that side of the tape can be smoothed firmly into place across the seam. The invention herein is particularly concerned with the latter type of tape, although it will be appreciated that this invention could be employed with drywall tapes that carry an adhesive. In a drywall taping process, it is often common for a drywaller to dip coat a length of drywall tape before pressing it into place across a seam, i.e., a length of drywall tape is manually dipped into a container of drywall compound, is manually removed, and, if necessary, excess drywall compound is allowed to drip or is otherwise stripped from the drywall tape before putting the tape in place across the seam. This could be a fairly messy and time consuming process, and this invention seeks to provide a drywall tape dispensing system that facilitates the process of applying drywall compound to a length of drywall tape for subsequent application of that tape across the seam of abutting drywall panels.

### SUMMARY OF THE INVENTION

This invention provides a drywall tape dispensing system that includes an open ended container retaining drywall compound, and a drywall tape dispenser. The drywall tape dispenser includes a frame having a feed end, a dispensing end, a support portion, a feed extension extending between the feed end and the support portion, and a dispensing extension extending between the support portion and the dispensing end. At least a portion of the frame fits within the open ended container such that the feed end and the dispensing end reside above the drywall compound, and the support portion rests within the drywall compound. A support guide on the support portion of the frame also rests within the drywall compound. A roll of drywall tape is retained at the feed end of the frame and is able to rotate about an axis. A metering guide is provided on the dispensing end of the frame. A leading edge of the drywall tape extends from the roll down the length of the feed extension and passes under the support guide, such that the drywall tape, at the support guide, is covered with drywall compound. The leading edge further extends from the support guide, up the length of the dispensing extension, and passes through the metering guide, such that the leading edge is accessible at the dispensing end of the frame. Pulling on the leading edge at the dispensing end pulls additional length of the drywall tape under the support guide and through the metering guide.

The frame is preferably contoured to fit intimately within the container that retains the drywall compound. In particular embodiments, the frame is made of opposed rail members. The metering guide preferably regulates the amount of drywall compound that is retained on each side of the drywall tape. In particular embodiments, the metering guide includes opposed guides, and, in yet additional embodiments, these opposed guides are set at from 1 to 6 mm apart, and in other embodiments, from 1.5 to 2.5 mm apart.

### BRIEF DESCRIPTION OF THE DRAWINGS

FIG. 1 is a side elevational view of an embodiment of a drywall tape dispensing system of this invention, with a bucket holding drywall compound shown in ghost lines;

FIG. 2 is a top view of the drywall tape dispenser portion;

FIG. 3 is an enclosed top view of a metering guide; and

FIG. 4 is a side elevational view similar to FIG. 1 showing the tape dispenser mounted in a bucket.

### PREFERRED EMBODIMENT OF THE INVENTION

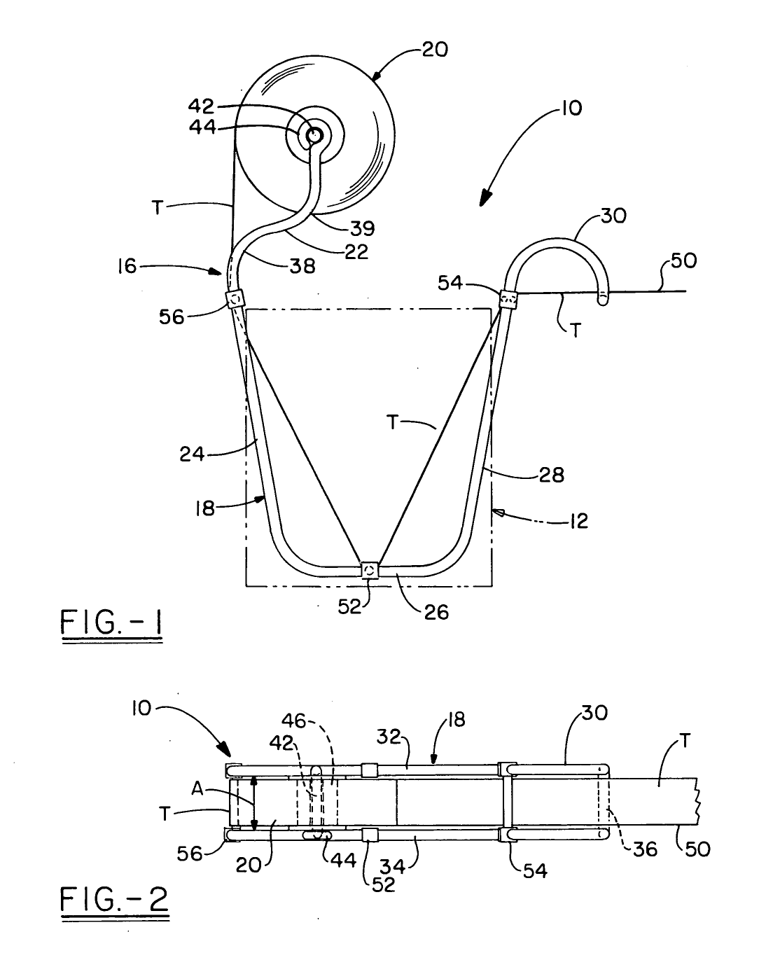

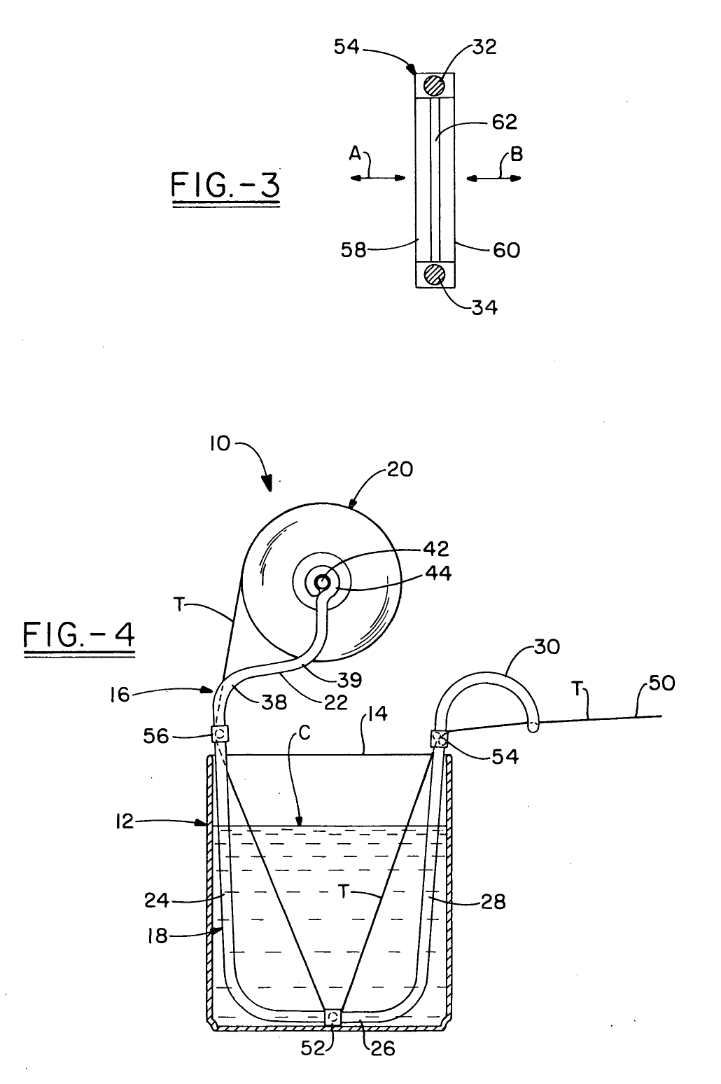

With reference to FIGS. 1 and 4, it can be seen that a drywall tape dispensing system in accordance with this invention is shown and designated by the numeral 10. System 10 includes open ended container 12, which retains drywall compound C at a level below its open top 14. System 10 further includes drywall tape dispenser 16, which is made up of frame 18, a plurality of guides (discussed and numbered below), and a roll 20 of drywall tape T. Frame 18 has feed end 22, feed extension 24 extending from feed end 22 to a first end of support portion 26, and dispensing extension 28, extending from an opposite end of support portion 26 to dispensing end 30.

Referring now to FIG. 2, it can be seen that, in accordance with a preferred embodiment, frame 18 is formed from opposed rails 32, 34, joined at dispensing end 30 by cross support 36. At feed end 22, opposed rails 32, 34 bend in the direction of dispensing end 30 as at bends 38, (FIGS. 1 and 4), and then bend upwardly at bends 39 (FIGS. 1 and 4) to their terminal ends. Rail 32 provides an axle 42 at its terminal end, extending crosswise toward the terminal end of rail 34, which forms an axle support 44. Frame 18 is preferably formed of a strong yet flexible material that is capable of permitting rails 32, 34 to be moved apart from each other at feed end 22, as represented by double-headed arrow A. Cross support 36 will keep rails 32, 34 in closer proximity as the rails extend from a spread apart feed end 22 toward the connected (via cross support 36) dispensing end 30.

By spreading rails 32, 34 apart at feed end 22, axle 42 can be distanced from axle support 44 to receive roll 20 (FIG. 1) and can thereafter be moved back together so that axle 42 is received by axle support 44, with a roll 20 of drywall tape to rotate about the axis defined thereby. A stainless steel material has been found to work well, providing some spring force from the spread feed end position back to the closed feed end position. Elastic bands may optionally be wrapped about opposed rails 32, 34 at chosen intervals, and preferably proximate feed end 22, to keep rails 32, 34 generally parallel to one another and to keep axle 42 received in axle support 44. They might be removed to install new roll 20 and then repositioned about rails 32, 34.

Leading end 50 of drywall tape T extends from roll 20 down the length of feed extension 24 to pass under support guide 52, and, because support guide 52 is provided on support portion 26, it rests within drywall compound C, thus ensuring that tape T, pulled from roll 20, and under support guide 52, is covered with drywall compound C. Leading end 50 then extends from support guide 52 through metering guide 54 proximate dispensing end 30. Leading end 50 is thus accessible at dispensing end 30, and pulling on leading end 50 pulls additional length of drywall tape T under support guide 52 and through metering guide 54. In particular embodiments, tape T also passes under feed guide 56 provided on feed extension 24. The bends at 38, 40 bring the outer diameter of roll 20 in better alignment with guide 56, making the dispensing of tape T off of roll 20 a little easier.

As shown in the figures, in some embodiments, extension guide 56 can be provided as an elastic band. Additionally, support guide 52 could be an elastic band. Extension guide 56 and support guide 52 simply help to ensure that tape T is forced into compound C as it extends from roll 20 to metering guide 54.

As seen in the cross section of FIG. 3, metering guide 54 includes opposed guides 58, 60, having a space 62 therebetween for the passage of tape T. By configuring opposed guides 58, 60 such that they may be selectively distanced from each other and selectively brought closer together, a different amount of compound C can be caused to remain in tape T as it is pulled through metering guide 54. Preferably, opposed guides 58, 60 are distanced at from 1 mm to 6 mm apart. In other embodiments, they are preferably distanced at from 1.5 to 4 mm, and in yet other embodiments, at from 1.5 to 2.5 mm. It will be appreciated that these opposed guides might be fixedly secured to opposed rails 32, 34 of frame 14 where they might be selectively removable and positionable thereon. Additionally, they might be configured so that the distance between opposed guides 58, 60 is adjustable by moving one or more of guides 58, 60 in the direction of arrows A or B.

In light of the foregoing, it should thus be evident that the process of the present invention, providing a drywall tape dispensing system, substantially improves the art. While, in accordance with the patent statutes, only the preferred embodiments of the present invention have been described in detail hereinabove, the present invention is not to be limited thereto or thereby. Rather, the scope of the invention shall include all modifications and variations that fall within the scope of the attached claims.

What is claimed is:

1. A drywall tape dispensing system comprising:
an open ended container retaining drywall compound; and
a drywall tape dispenser comprising:
a frame having a feed end, a dispensing end, a support portion, a feed extension extending between said feed end and said support portion, and a dispensing extension extending between said support portion and said dispensing end, wherein at least a portion of said frame sits within said open ended container such that said feed end and said dispensing end reside above said drywall compound and said support portion rests within said drywall compound;
a roll of drywall tape retained at said feed end to rotate about an axis;
a support guide on said support portion of said frame such that said support guide rests within said drywall compound, and
a metering guide on said dispensing end, wherein a leading edge of said drywall tape extends from said roll down the length of said feed extension to pass under said support guide, such that said drywall tape, at said support guide, is covered with drywall compound, and, from said support guide, extends up the length of said dispensing extension to pass through said metering guide and be accessible at said dispensing end such that pulling on said leading edge accessible at said dispensing end pulls additional length of said drywall tape under said support guide and through said metering guide.

2. The drywall tape dispensing system of claim 1, wherein said metering guide includes opposed guides, said opposed guides scrapping excess drywall compound off of top and bottom surfaces of said drywall tape.

3. The drywall tape dispensing system of claim 1, wherein said feed end and said dispensing end of said frame extend above said open end of said container.

4. The drywall tape dispensing system of claim 1, further comprising an extension guide on said feed extension.

5. The drywall tape dispensing system of claim 1, wherein said frame is made of opposed rail members.

6. The drywall tape dispensing system of claim 5, wherein said opposed rail members are joined at said dispensing end by a cross support, and are not joined at said feed end, such that said opposed rails can be pulled apart from each other at said feed end.

7. The drywall tape dispensing system of claim 6, wherein one of said opposed rails, at said feed end, provides an axle, and the other of said opposed rails, at said feed end, provides an axle receipt.
